(19) United States
(12) Patent Application Publication
(10) Pub. No.: US 2008/0032258 A1
(43) Pub. Date: Feb. 7, 2008

(54) Microimplant placement guide

(75) Inventors: Hee Moon Kyung, Daegu (KR); Hyo Sang Park, Daegu (KR)

Correspondence Address: PARK LAW FIRM, 3255 WILSHIRE BLVD, SUITE 1110, LOS ANGELES, CA, 90010, US

(73) Assignee: Dentos co., Ltd

(21) Appl. No.: 11/546,187

(22) Filed: Oct. 11, 2006

(30) Foreign Application Priority Data
Aug. 7, 2006 (KR) 10-2006-0074362

(51) Int. Cl. A61C 3/00; A61C 8/00

(52) U.S. Cl. 433/75; 433/18; 433/173

(57) ABSTRACT

A microimplant placement guide is disclosed. The microimplant placement guide includes a jig having a through-hole and a guide hole for guiding a dental drill or a microimplant to be inserted into an alveolar bone, a supporting member including a flexible wire which passes through the through-hole of the jig and is deformed according to a placement position and direction of the microimplant, and a holder which is manufactured based on a patient's teeth model and fixes both ends of the supporting member while determining the accurate placement position and direction of the microimplant. Since the microimplant placement is achieved by the microimplant placement guide obtained from the patient's teeth model, the accuracy and safety of the operation are increased.

### CLAIMING FOREIGN PRIORITY

The applicant claims and requests a foreign priority, through the Paris Convention for the Protection of Industrial Property, based on patent applications filed in the Republic of Korea (South Korea) with the filing date of Aug. 7, 2006 with the patent application number 10-2006-0074362 by the applicant, the contents of which are incorporated by reference into this disclosure as if fully set forth herein.

### BACKGROUND OF THE INVENTION

1. Field of the Invention

The present invention relates to a microimplant placement guide, and more particularly to a microimplant placement guide capable of determining an accurate placement position and direction of a microimplant which is temporarily placed in an alveolar bone to support an orthodontic instrument and apply a straightening force to teeth.

2. Description of the Related Art

When straightening irregular teeth, brackets having holes are adhered to teeth by using a resin, and a flexible wire passes through the holes of the brackets to apply a straightening force to the teeth.

Besides the flexible wire, a Ni—Ti coil spring and a rubber band may be also used for teeth movement. The Ni—Ti coil spring and the rubber band can be connected to a microimplant placed in an alveolar bone, and apply the straightening force to the teeth.

As shown in FIG. 1a, a conventional microimplant 100 for orthodontic treatment comprises a screw part 200 which is placed in an alveolar bone, a tightening part 300 which is formed on the screw part 200 for easily tightening the screw part 200, and a supporting part 400 which is formed on the tightening part 300 for fixing a Ni—Ti coil spring or a rubber band.

The conventional microimplant 100 depicted in FIG. 1a is disclosed in Korean Patent No. 0398463 and U.S. Patent Application No. 2002/0182560.

As shown in FIG. 1b, when placing the microimplant 100 in the alveolar bone A, local anesthesia is first performed, and the placement position and direction are determined. A microimplant placement hole H is drilled by a dental drill D, and the microimplant 100 is inserted into the hole H.

Besides the above microimplant placement method, the microimplant placement may be performed in other ways. As an example, the microimplant 100 may be placed in the alveolar bone A without drilling the microimplant placement hole H in the alveolar bone A.

The microimplant 100 must be placed with an accurate angle and by an accurate length at a safe and accurate position. When the microimplant 100 is placed inaccurately, the root of the teeth and the alveolar bone A may be damaged or wounded, and the wound may become inflamed. Further, failure rate may be increased.

However, the prior art has a disadvantage that the position and the direction of the microimplant placement are verified by the naked eye and the drilling of the placement hole H and the microimplant placement are dependent on a doctor's experience and sense. Especially, when the microimplant 100 is placed inside upper and lower jaws, the placement region is not seen well with the naked eye. Accordingly, the accuracy of the microimplant placement is decreased, and the risk and the difficulty in the operation are increased.

Further, when driving the dental drill D for drilling the placement hole H in the alveolar bone A, the rotating drill D twists a teethridge and causes bleeding and inflammation.

### SUMMARY OF THE INVENTION

Therefore, the present invention has been made in view of the above problems, and it is an object of the present invention to provide a microimplant placement guide capable of determining an accurate placement position and direction of a microimplant which is temporarily placed in an alveolar bone to support an orthodontic instrument and apply a straightening force to teeth.

In accordance with the present invention, the above and other objects can be accomplished by the provision of a microimplant placement guide comprising: a jig including a through-hole and a guide hole for guiding a dental drill and a microimplant to be inserted into an alveolar bone when drilling a placement hole with the dental drill and placing the microimplant in the alveolar bone; a supporting member including a flexible wire which passes through the through-hole of the jig to support the jig and is deformed according to a placement position and direction of the microimplant; and a holder which is manufactured based on a patient's teeth model by using a dental material and fixes both ends of the supporting member while determining the accurate placement position and direction of the microimplant.

Preferably, the jig may include a first body, a second body and a connecting part for connecting the first body and the second body. The first body and the second body split open and are closed about the axis of the connecting part.

Preferably, the first body may be formed with a knob at an end opposite to the connecting part and fixing protrusions near the knob, and the second body may be formed with fixing recesses corresponding to the fixing protrusions of the first body so that the fixing protrusions are fitted into the fixing recesses.

Preferably, the holder may be configured such that the dental material (e.g., a resin) is coated on two or more teeth of the patient's teeth model and hardened.

### BRIEF DESCRIPTION OF THE DRAWINGS

The above and other objects, features and other advantages of the present invention will be more clearly understood from the following detailed description taken in conjunction with the accompanying drawings, in which:

FIG. 1a is a perspective view showing a conventional microimplant for use in straightening of irregular teeth;

FIG. 1b is a schematic view showing a conventional microimplant placement procedure;

FIG. 2a is a perspective view showing a closed state of a jig of a microimplant placement guide in accordance with a preferred embodiment of the present invention;

FIG. 2b is a perspective view showing an opened state of a jig depicted in FIG. 2a;

FIG. 2c is a transverse cross-sectional view showing a closed state of a jig depicted in FIG. 2a;

FIG. 2d is a longitudinal cross-sectional view showing a closed state of a jig depicted in FIG. 2a;

FIG. 3 is a perspective view showing a modification of a jig of a microimplant placement guide;

FIG. 4 is a perspective view showing an overall structure of a microimplant placement guide in accordance with a preferred embodiment of the present invention;

FIG. 5a is a schematic view showing procedures of determining a placement position and direction on a teeth model and placing a microimplant; and

FIG. 5b is a perspective view showing a procedure of drilling a placement hole in an alveolar bone with a dental drill by using a microimplant placement guide in accordance with a preferred embodiment of the present invention.

### DESCRIPTION OF THE PREFERRED EMBODIMENTS

Now, preferred embodiments of the present invention will be described in detail with reference to the annexed drawings.

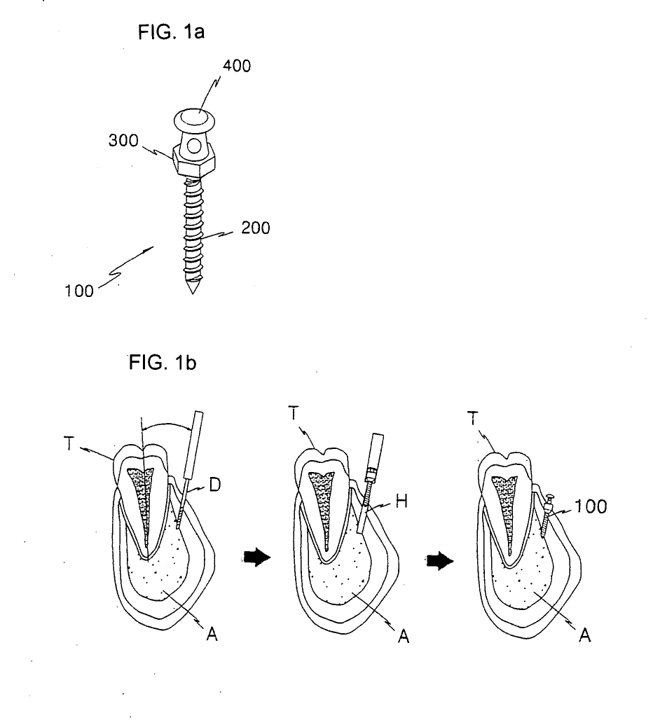

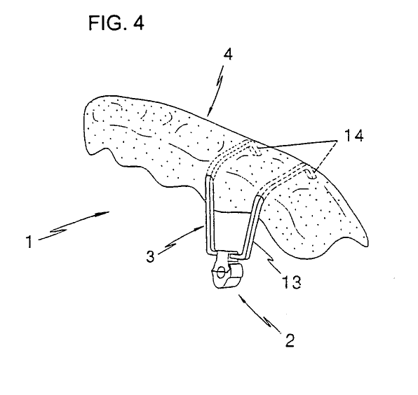

FIG. 4 is a perspective view showing an overall structure of a microimplant placement guide in accordance with a preferred embodiment of the present invention. As shown in the drawing, a microimplant placement guide 1 comprises a jig 2 for guiding a dental drill D or a microimplant 100 (see FIG. 1a) which is placed in an alveolar bone A for orthodontic treatment, a supporting member 3 for supporting the jig 2, and a holder 4 which is coupled to both ends of the supporting member 3 and temporarily covers a patient's teeth T to determine a placement position and direction of the microimplant 100.

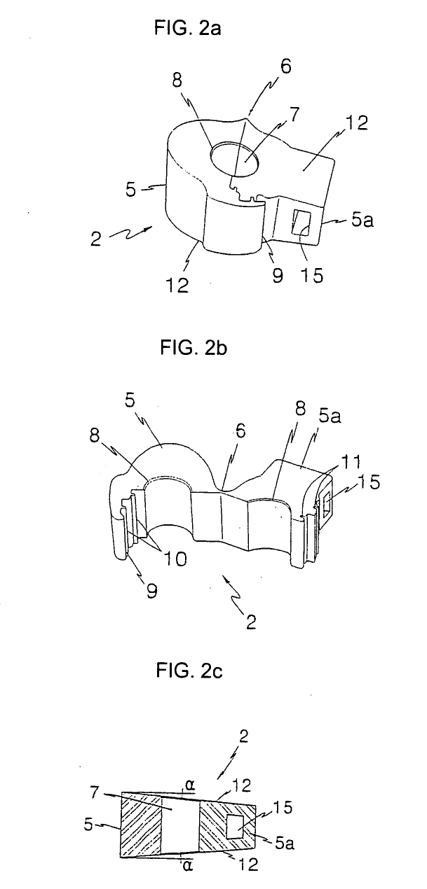

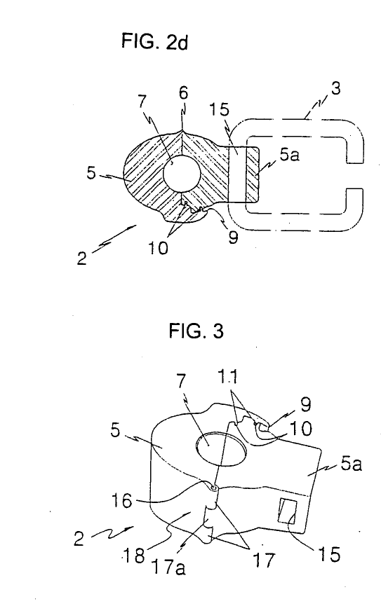

As shown in FIGS. 2a to 2d, the jig 2 includes first and second bodies 5 and 5a which are connected to each other by a flexible connecting part 6. The first and second bodies 5 and 5a and the connecting part 6 are made unitarily from a resin material by molding, so as to have flexibility. The first and second bodies 5 and 5a split open and are closed about the axis of the connecting part 6. The jig 2 enables a doctor to determine the accurate placement position and direction, and guides the microimplant 100 placed in the alveolar bone A. When the microimplant 100 is placed in the alveolar bone A to a certain extent, the jig 2 is removed from the microimplant 100 by opening the first and second bodies 5 and 5a, so as to achieve complete placement of the microimplant 100, more exactly, the screw part 200 (see FIG. 1a), in the alveolar bone A.

The first body 5 is formed with a semi-circular concave portion at an inner surface, and fixing protrusions 10 near a front end opposite to the connecting part 6. The second body 5a is formed with a semi-circular concave portion at an inner surface, and fixing recesses 11 near a front end opposite to the connecting part 6, into which the fixing protrusions 10 of the first body 5 are fitted. When the fixing protrusions 10 of the first body 5 are fitted into the fixing recesses 11 of the second body 5a to close the bodies 5 and 5a, the semi-circular concave portions of the first and second bodies 5 and 5a form a circular guide hole 7, through which the microimplant 100 passes. The first body 5 is further formed with a knob 9 at the front end. When splitting the first and second bodies 5 and 5a, the fixing protrusions 10 are easily separated from the fixing recesses 11 by pulling the knob 9.

FIG. 3 is a perspective view showing a modification of the jig. As shown in the drawing, the first and second bodies 5 and 5a of the jig 2 are provided independently, and connected to each other by a hinge part 18. The hinge part 18 includes pin supporting members 17 and 17a formed at ends of the first and second bodies 5 and 5a, opposite to the fixing protrusions 10 and the fixing recesses 11. The hinge part 18 further includes a hinge pin 16 inserted into the pin supporting members 17 and 17a. Therefore, the first and second bodies 5 and 5a split open and are closed about the axis of the hinge part 18.

The second body 5a of the jig 2 is formed with a through-hole 15, through which a flexible wire 13 of the supporting member 3 (see FIG. 4) passes. The through-hole 15 is formed as a polygon (preferably, a rectangle), so that the jig 2 can be fixedly supported by the supporting member 3.

Slanted portions 8 are formed at both periphery of the guide hole 7 formed at the first and second bodies 5 and 5a of the jig 2, so as to guide the dental drill D or the microimplant 100 to be easily inserted into the guide hole 7.

Both contact surfaces 12 of the first and second bodies 5 and 5a of the jig 2 are slanted downward from the first body 5 to the second body 5a by an inclination a, so that the jig 2 contacts closely and stably to the teethridge.

The inclination a of the contact surfaces 12 of the jig 2 is determined differently according to a structure of a patient's oral cavity and the placement position and the direction of the microimplant 100.

The supporting member 3 connectingly mounted between the second body 5a of the jig 2 and the holder 4 uses the flexible wire 13 so as to adjust the placement direction (angle) of the microimplant 100. The flexible wire 13 has a cross-sectional shape of a polygon (preferably, a rectangle) which is the same as the shape of the through-hole 15 formed at the second body 5a of the jig 2.

The flexible wire 13 passes through the through-hole 15 formed at the second body 5a of the jig 2, and both portions are bent in an opposite direction to the jig 2. Then, both end portions are bent again to form fixing portions 14. The overall shape and angle of such a flexible wire 13 are modified according to the placement direction of the microimplant 100. When manufacturing the holder 4 by using a dental material (e.g., a resin), the fixing portions 14 of the flexible wire 13 are fixed to the holder 4.

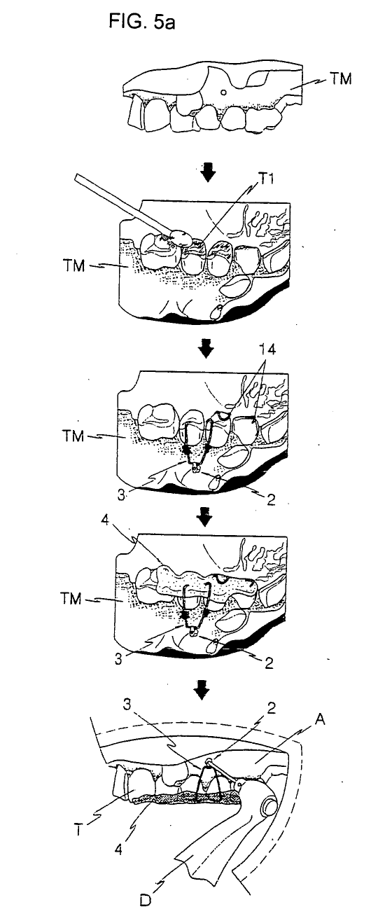

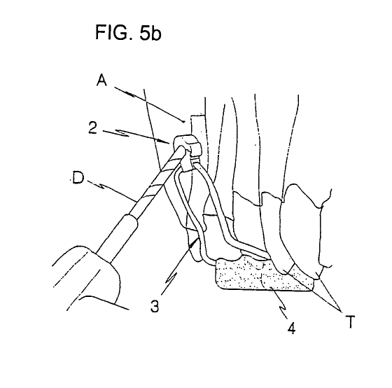

As shown in FIG. 5a, the holder 4 is obtained from a teeth model TM which is patterned after the patient's real teeth. Describing in detail, the placement position and direction of the microimplant 100 are determined on the teeth model TM patterned after the patient's real teeth. The dental material like a resin is first coated on surfaces of teeth T of the teeth model TM, and hardened. The fixing portions 14 of the flexible wire 13 are set on the first resin-layer coated on the teeth model TM. Then, the dental material like a resin is secondarily coated on the fixing portions 14 of the flexible wire 13 and the first resin-layer, and hardened. Therefore, the supporting member 3 is securely fixed to the holder 4.

In order to increase supporting and fixing forces of the holder 4 and avoid interference in the operation, the holder 4 is patterned after three or four teeth of the teeth model TM, which includes a tooth T1 in which the microimplant 100 is intended to be actually placed.

After the microimplant placement guide 1 is manufactured on the patient's teeth model TM by the aforesaid procedures while determining the accurate placement position and direction of the microimplant 100, the microimplant placement guide 1 is removed from the teeth model TM and put on the patient's real teeth T.

Hereinafter, the operation using the microimplant placement guide 1 of the present invention will be described in detail. When the holder 4 manufactured based on the patient's teeth model TM is put on the patient's real teeth T corresponding thereto, the placement position and direction of the microimplant 100 are determined accurately.

When the holder 4 is put on the patient's real teeth T, the contact surfaces 12 formed at the first and second bodies 5 and 5a of the jig 2 contact closely to the patient's teethridge.

The dental drill D is guided by the slanted portions 8 of the jig 2 and passes through the guide hole 7 to drill the placement hole H in the alveolar bone A according to the placement position and direction which are accurately determined from the teeth model TM. Although the dental drill D is rotated to drill the placement hole H in the alveolar bone A, the teethridge is prevented from being twisted and injured because the contact surfaces 12 of the jig 2 press the teethridge.

After drilling the placement hole H in the alveolar bone A (it does not matter even if the drilling process is omitted), the microimplant 100 is inserted through the guide hole 7 of the jig 2. By using a dental driver, the microimplant 100 is started to be placed in the alveolar bone A. When the tightening part 300 of the microimplant 100 approaches the first and second bodies 5 and 5a of the jig 2, the microimplant placement guide 1 should be removed from the patient's real teeth T to completely place the screw part 200 of the microimplant 100 in the alveolar bone A.

When removing the microimplant placement guide 1 from the patient's real teeth T, the dental driver is first removed from the patient's mouth. Then, by pulling the knob 9 formed at the first body 5 of the jig 2, the fixing protrusions 10 of the first body 5 are separated from the fixing recesses 11 of the second body 5a, and the first and second bodies 5 and 5a split open about the axis of the connecting part 6. The opened first and second bodies 5 and 5a of the jig 2 are pushed away from the microimplant 100. At the same time, the holder 4 is removed from the patient's real teeth T. Then, the overall microimplant placement guide 1 is drawn out of the patient's mouth.

After the microimplant placement guide 1 is drawn out of the patient's mouth, the interference between the tightening part 300 of the microimplant 100 and the first and second bodies 5 and 5a of the jig 2 is eliminated. Finally, the dental driver is brought again in the patient's mouth to rotate the microimplant 100 so that the screw part 200 of the microimplant 100 is completely placed in the alveolar bone A.

As apparent from the above description, the present invention provides a microimplant placement guide capable of guiding the microimplant to be placed in the alveolar bone in an accurate position and direction. Since the microimplant placement is achieved by the microimplant placement guide obtained from a patient's teeth model without depending on a doctor's experience and sense, the accuracy and safety of the operation are increased.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A microimplant placement guide comprising:
a jig including a through-hole and a guide hole for guiding a dental drill and a microimplant to be inserted into an alveolar bone when drilling a placement hole with the dental drill and placing the microimplant in the alveolar bone;
a supporting member including a flexible wire which passes through the through-hole of the jig to support the jig and is deformed according to a placement position and direction of the microimplant; and
a holder which is manufactured based on a patient's teeth model by using a dental material and fixes both ends of the supporting member while determining the accurate placement position and direction of the microimplant.

2. The microimplant placement guide according to claim 1, wherein the jig includes a first body, a second body and a connecting part for connecting the first body and the second body, the first body and the second body splitting open and being closed about the axis of the connecting part,
and wherein the first body is formed with a knob at an end opposite to the connecting part and fixing protrusions near the knob, and the second body is formed with fixing recesses corresponding to the fixing protrusions of the first body so that the fixing protrusions are fitted into the fixing recesses.

3. The microimplant placement guide according to claim 1, wherein the jig includes a first body, a second body and a hinge part for connecting the first body and the second body, the first body and the second body splitting open and being closed about the axis of the hinge part.

4. The microimplant placement guide according to claim 1, wherein the through-hole of the jig is formed as a polygon, and the flexible wire of the supporting member has a cross-sectional shape of a polygon corresponding to the through-hole.

5. The microimplant placement guide according to claim 1, wherein a slanted portion is formed at a periphery of the guide hole of the jig to guide the dental drill and the microimplant to pass through the guide hole.

6. The microimplant placement guide according to claim 1, wherein the holder is configured such that the dental material is coated on two or more teeth of the patient's teeth model and hardened,
and wherein the dental material is a resin.

7. The microimplant placement guide according to claim 2, wherein surfaces of the first body and the second body of the jig are slanted to contact closely to a patient's teethridge.

8. The microimplant placement guide according to claim 2, wherein the first body, the second body and the connecting part of the jig are made unitarily from a resin to have flexibility.
